(19) United States
(12) Patent Application Publication
(10) Pub. No.: US 2025/0265380 A1
(43) Pub. Date: Aug. 21, 2025

(54) METHOD, DEVICE, MEDIUM, AND PRODUCT FOR PATTERN DESIGN IN FILAMENT WINDING

(71) Applicant: Hefei University of Technology, Hefei (CN)

(72) Inventors: Jianhui FU, Hefei (CN); Lei ZU, Hefei (CN); Qian ZHANG, Hefei (CN); Guiming ZHANG, Hefei (CN); Qiaoguo WU, Hefei (CN); Helin PAN, Hefei (CN); Lichuan ZHOU, Hefei (CN); Huabi WANG, Hefei (CN)

(73) Assignee: Hefei University of Technology, Hefei (CN)

(21) Appl. No.: 19/055,565

(22) Filed: Feb. 18, 2025

(30) Foreign Application Priority Data
Feb. 20, 2024 (CN) 202410190038.3

(51) Int. Cl. G06F 30/17

(52) U.S. Cl. CPC G06F 30/17

(57) ABSTRACT

A method, device, medium, and product for pattern design in filament winding is provided. The method includes: acquiring parameter data of a target elbow pipe mandrel; constructing a mandrel geometric model according to the geometric dimension parameters; the mandrel geometric model includes a geodesic mathematical model of a ring segment and a non-geodesic mathematical model of a cylindrical segment; the ring segment is an elliptical section annular elbow pipe; the cylindrical segment is an elliptical section pipe; determining number of yarns of the ring segment according to the geodesic mathematical model and set parameter data, and determining geodesic trajectory information of the ring segment; determining non-geodesic trajectory information of the cylindrical segment according to the non-geodesic mathematical model and a set slip coefficient; determining a filament winding pattern according to the geodesic trajectory information of the ring segment and the non-geodesic trajectory information of the cylindrical segment.

### CROSS-REFERENCE TO THE RELATED APPLICATIONS

This application is based upon and claims priority to Chinese Patent Application No. 202410190038.3, filed on Feb. 20, 2024, the entire contents of which are incorporated herein by reference.

### TECHNICAL FIELD

The present invention relates to the field of pattern design, in particular to a method, device, medium, and product for pattern design in filament winding.

### BACKGROUND

Compared with the conventional plastic elbow pipe and metal elbow pipe, the carbon fiber composite elbow pipe has the characteristics of high modulus, high strength, good corrosion resistance and long life, which is widely used in the fields of aerospace, marine development, petroleum exploitation and smelting, architecture water-supply and drainage, chemical industry, food processing and so on. Filament winding technology is an advanced manufacturing technology that controls the relative movement between the pay-out eye and the mandrel by the winding machine equipment to wind the resin-impregnated fiber yarn evenly and stably on the mandrel surface according to a certain law, and then performs solidifying and forming, so that it can meet the requirements of mechanical properties.

Compared with other composite material forming processes, the elbow pipe produced by filament winding technology has the advantages of high efficiency, low cost and product with high strength, which is an ideal method to produce the elbow pipe and the joint of the elbow pipe. The filament winding pattern of elbow pipe is closely related to fiber distribution, winding of process and winding motion stability, which is of great significance in improving the structural properties of the forming products.

At present, the research on the design of elbow pipe pattern is only for circular section elbow pipe, and cannot be applied to the pattern design of elliptical section elbow pipe. Although some commercially available software (such as CADWIND software) can realize the pattern design of elliptical section elbow pipe, due to the confidentiality requirements, its specific method is not reported in public. Therefore, it is very important to design a uniformly covered and stable pattern suitable for the winding of the elliptical section elbow pipe, to improve the forming quality and manufacturing efficiency of composite elbow pipes with filament winding, so as to facilitate the filament winding design and manufacturing of complex products with high added value, and to expand the application field of filament winding technology.

### SUMMARY

An objective of the present invention is to provide a method, device, medium, and product for pattern design in filament winding, which can improve the forming quality and manufacturing efficiency of the filament winding composite elbow pipe.

In order to achieve the above objective, the present invention provides the following scheme:
a method for pattern design in filament winding, the method includes:
acquiring parameter data of a target elbow pipe mandrel; the parameter data includes: geometric dimension parameters;
constructing a mandrel geometric model according to the geometric dimension parameters; the mandrel geometric model includes a geodesic mathematical model of a ring segment and a non-geodesic mathematical model of a cylindrical segment; the ring segment is an elliptical section annular elbow pipe; the cylindrical segment is an elliptical section pipe;
determining number of yarns of the ring segment according to the geodesic mathematical model and set parameter data, and determining geodesic trajectory information of the ring segment; the set parameter data includes: an initial winding angle and a yarn width; the geodesic trajectory information of the ring segment includes: a winding angle and a center rotation angle;
determining non-geodesic trajectory information of the cylindrical segment according to the non-geodesic mathematical model and a set slip coefficient; the non-geodesic trajectory information of the cylindrical segment includes: a fiber path winding angle and a fiber path center rotation angle;
determining a filament winding pattern according to the geodesic trajectory information of the ring segment and the non-geodesic trajectory information of the cylindrical segment by using a continued fraction theory.

Optionally, a construction method for the mandrel geometric model specifically includes:
determining a parametric expression according to the geometric dimension parameters; the parametric expression specifically includes:

$$\vec{T} ( θ , φ ) = {[ \begin{matrix}( R + a cos φ ) cos θ \\ ( R + a cos φ ) sin θ \\ b sin φ\end{matrix} ]}^{T}$$

obtaining the mandrel geometric model by processing the parametric expression according to a differential geometry theory; the mandrel geometric model specifically includes:

$$\{ \begin{matrix}E = \vert \vec{{T}_{θ}} {\vert}^{2} = {( R + a cos φ )}^{2} \\ F = 0 \\ G = \vert \vec{{T}_{φ}} {\vert}^{2} = {a}^{2} {sin}^{2} φ + {b}^{2} {cos}^{2} φ\end{matrix}$$

where, \vec{T}(θ, φ) is a parameter vector; R is a bending radius; a is an elliptical long semi-axis of elliptical section; b is an elliptical short semi-axis of elliptical section; θ is a bending angle; φ is a center rotation angle; T is a matrix transpose; \vec{T}_{θ} is a partial derivative of the bending angle θ; T̅_{φ} is a partial derivative of the center rotation angle φ; E is a first expression of the parametric expression; F is a second expression of the parametric expression; G is a third expression about parametric expression.

Optionally, the geodesic mathematical model specifically includes:

$$\frac{d {α}_{1}}{d {φ}_{1}} = - \frac{a sin {φ}_{1}}{R + a cos {φ}_{1}} cot {α}_{1} ;$$

$$\frac{d θ}{d {φ}_{1}} = \frac{\sqrt{G}}{R + a cos {φ}_{1}} cot {α}_{1} ;$$

where, α₁ is a winding angle; φ₁ is a center rotation angle; θ is the bending angle; a is the elliptical long semi-axis of elliptical section; R is a bending radius; G is the third expression about parametric expression.

Optionally, the non-geodesic mathematical model specifically includes:

$$\frac{d {α}_{2}}{dy} = - \frac{λ ab {sin}^{2} {α}_{2}}{G \sqrt{G} cos {α}_{2}} ;$$

$$\frac{d {φ}_{2}}{dy} = \frac{tan {α}_{2}}{\sqrt{G}} ;$$

where, α₂ is a fiber path winding angle; a is the elliptical long semi-axis of elliptical section; b is an elliptical short semi-axis of elliptical section; G is the third expression about parametric expression; φ₂ is a fiber path center rotation angle; λ is a set slip coefficient; y is axial position information of the central axis.

Optionally, the method for determining the geodesic trajectory information of the ring segment specifically includes:
determining the bending angle according to an initial winding angle; the bending angle is an angle spanned by a geodesic within a set period of the center rotation angle;
determining the number of yarns corresponding to an outer arc of a set period according to the bending angle and the yarn width;
determining path information about each yarn according to the geodesic mathematical model and set parameter data;
determining the geodesic trajectory information of the ring segment according to all path information.

Optionally, determining the non-geodesic trajectory information of the cylindrical segment according to the non-geodesic mathematical model and the set slip coefficient, specifically including:
determining a length of transition segment according to the non-geodesic mathematical model and the set slip coefficient;
judging whether the set slip coefficient satisfies a set requirement according to the length of the transition segment and the length of the cylindrical segment;
if the length of the transition segment is greater than the length of the cylindrical segment, increasing the length of the cylindrical segment or changing the set slip coefficient within a set range to obtain modification information;
determining non-geodesic trajectory information of the cylindrical segment according to the non-geodesic mathematical model and the modification information;
if the length of the transition segment is not greater than the length of the cylindrical segment, determining the non-geodesic trajectory information of the cylindrical segment according to the non-geodesic mathematical model.

A computer device, the computer device includes: memory, a processor, and computer instructions stored on the memory and runnable on the processor, the processor executing the computer program to implement the steps of the method for pattern design in filament winding described above.

A computer-readable storage medium, the computer-readable storage medium has stored a computer program, the steps of the method for pattern design in filament winding described above are implemented when the computer program is executed by the processor.

A computer program product, the computer program product includes a computer program, the steps of the method for pattern design in filament winding described above are implemented when the computer program is executed by the processor.

According to the specific embodiments provided by the present invention, the present invention discloses the following technical effects:
the present invention provides a method, device, medium, and product for pattern design in filament winding, by acquiring parameter data of the target elbow pipe mandrel; constructing the mandrel geometric model according to the geometric dimension parameters; determining the number of the yarns in the ring segment according to the geodesic mathematical model and the set parameter data, and determining the geodesic trajectory information of the ring segment; determining the non-geodesic trajectory information of the cylindrical segment according to the non-geodesic mathematical model and set slip coefficient; and determining a filament winding pattern according to the geodesic trajectory information of the ring segment and the non-geodesic trajectory information of the cylindrical segment by using a continued fraction theory, so as to design a uniformly covered and stable pattern suitable for the winding of elliptical elbow pipes, improve the forming quality and manufacturing efficiency of filament winding composite material elbow pipes, promote the design and manufacturing of filament winding forming of high value-added complex products, and expand the application field of filament winding technology; therefore, the present invention can improve the forming quality and the manufacturing efficiency of the filament winding composite elbow pipe.

### BRIEF DESCRIPTION OF THE DRAWINGS

To explain the embodiments of the present invention or the technical solutions in the prior art more clearly, a brief introduction will be made to the accompanying drawings used in the embodiments or the description of the prior art. It is obvious that the drawings in the description below are only some embodiments of the present invention, and those ordinarily skilled in the art can obtain other drawings according to these drawings without creative work.

FIG. 1 is a schematic diagram of a method for pattern design in filament winding provided by embodiment 1 of the present invention;

FIG. 2 is a schematic diagram of a filament winding pattern design in practical application.

FIG. 3 is a schematic diagram of parameters corresponding to a mandrel geometric model;

FIG. 4 is a schematic diagram of a mandrel model;

FIG. 5 is a schematic diagram of a winding angle diagram at a starting point of a ring segment;

FIG. 6 is a schematic diagram of a fiber doffing path at outward of a ring segment;

FIG. 7 is a schematic diagram of a fiber doffing path for one cycle;

FIG. 8 is a schematic diagram of a fiber doffing path for all cycles.

### DETAILED DESCRIPTION OF THE EMBODIMENTS

The following clearly and completely describes the technical solutions in embodiments of the present invention with reference to the drawings of the embodiments of the present invention. Apparently, the described embodiments are only some but not all of the embodiments of the present invention. All other embodiments obtained by those of ordinary skill in the art based on the embodiments of the present invention without involving any creative effort shall fall within the scope of protection of the present invention.

The objective of the present invention is to provide a method, device, medium, and product for pattern design in filament winding, which can improve the forming quality and manufacturing efficiency of the filament winding composite elbow pipe.

In order to make the above objective, characteristics and advantages of the present invention more obvious and easy to understand, the following is a further detailed description of the present invention in combination with the drawings and specific embodiments.

### Embodiment 1

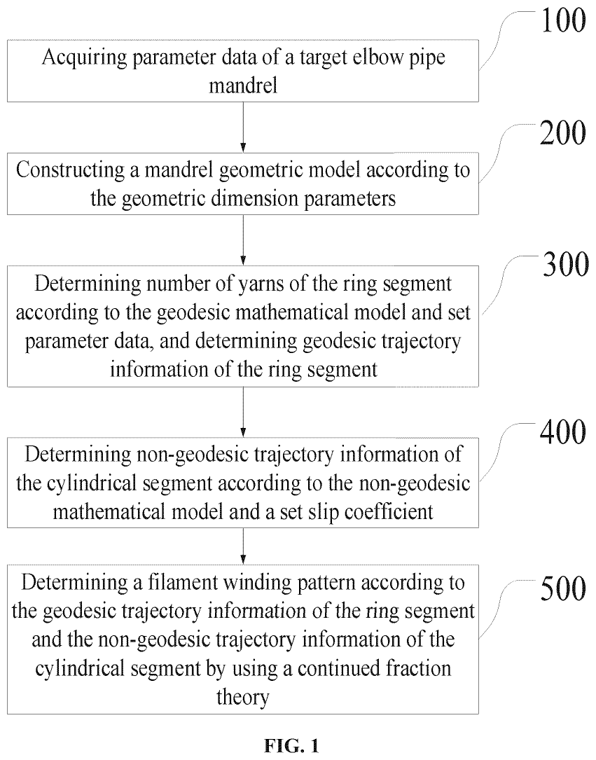

As shown in FIG. 1, the embodiment of the present invention provides a method for pattern design in filament winding, the method includes:
step 100: parameter data of a target elbow pipe mandrel are acquired. The parameter data includes: geometric dimension parameters.
Step 200: a mandrel geometric model is constructed according to the geometric dimension parameters. The mandrel geometric model includes a geodesic mathematical model of a ring segment and a non-geodesic mathematical model of a cylindrical segment; the ring segment is an elliptical section annular elbow pipe; the cylindrical segment is an elliptical section pipe;
Step 300: the number of yarns of the ring segment is determined according to the geodesic mathematical model and set parameter data, and geodesic trajectory information of the ring segment is determined. The set parameter data includes: an initial winding angle and a yarn width; the geodesic trajectory information of the ring segment includes: a winding angle and a center rotation angle;
Step 400: non-geodesic trajectory information of the cylindrical segment is determined according to the non-geodesic mathematical model and a set slip coefficient. The non-geodesic trajectory information of the cylindrical segment includes: a fiber path winding angle and a fiber path center rotation angle.
Step 500: a filament winding pattern is determined according to the geodesic trajectory information of the ring segment and the non-geodesic trajectory information of the cylindrical segment by using a continued fraction theory.

In one embodiment, a construction method for the mandrel geometric model specifically includes:
a parametric expression is determined according to the geometric dimension parameters; the parametric expression specifically includes:

$$\vec{T} ( θ , φ ) = {[ \begin{matrix}( R + a cos φ ) cos θ \\ ( R + a cos φ ) sin θ \\ b sin φ\end{matrix} ]}^{T} ;$$

the mandrel geometric model is obtained by processing the parametric expression according to a differential geometry theory; the mandrel geometric model specifically includes:

$$\{ \begin{matrix}E = \vert \vec{{T}_{θ}} {\vert}^{2} = {( R + a cos φ )}^{2} \\ F = 0 \\ G = \vert \vec{{T}_{φ}} {\vert}^{2} = {a}^{2} {sin}^{2} φ + {b}^{2} {cos}^{2} φ\end{matrix} ;$$

where, \vec{T}(θ, φ) is a parameter vector; R is a bending radius; a is an elliptical long semi-axis of elliptical section; b is an elliptical short semi-axis of elliptical section; θ is a bending angle; φ is a center rotation angle; T is a matrix transpose; \vec{T}_{θ} is a partial derivative of the bending angle θ; \vec{T}_{φ} is a partial derivative of the center rotation angle φ; E is a first expression of the parametric expression; F is a second expression of the parametric expression; G is a third expression about parametric expression.

The geodesic mathematical model specifically includes:

$$\frac{d {α}_{1}}{d {φ}_{1}} = - \frac{a sin {φ}_{1}}{R + a cos {φ}_{1}} cot {α}_{1} ;$$

$$\frac{d θ}{d {φ}_{1}} = \frac{\sqrt{G}}{R + a cos {φ}_{1}} cot {α}_{1} ;$$

where, α₁ is a winding angle; φ is a center rotation angle; θ is the bending angle; a is the elliptical long semi-axis of elliptical section; R is a bending radius; G is the third expression about parametric expression.

The non-geodesic mathematical model specifically includes:

$$\frac{d {α}_{2}}{dy} = - \frac{λ ab {sin}^{2} {α}_{2}}{G \sqrt{G} cos {α}_{2}} ;$$

$$\frac{d {φ}_{2}}{dy} = \frac{tan {α}_{2}}{\sqrt{G}} ;$$

where, α₂ is the fiber path winding angle; a is the elliptical long semi-axis of elliptical section; b is an elliptical short semi-axis of elliptical section; G is the third expression about parametric expression; φ₂ is a fiber path center rotation angle; λ is a set slip coefficient; y is axial position information of the central axis.

The method for determining the geodesic trajectory information of the ring segment specifically includes:
the bending angle is determined according to an initial winding angle; the bending angle is an angle spanned by a geodesic within a set period of the center rotation angle.

The number of yarns corresponding to an outer arc of a set period is determined according to the bending angle and the yarn width;

The path information about each yarn is determined according to the geodesic mathematical model and set parameter data;

The geodesic trajectory information of the ring segment is determined according to all path information.

The non-geodesic trajectory information of the cylindrical segment is determined according to the non-geodesic mathematical model and the set slip coefficient, specifically including:
a length of transition segment is determined according to the non-geodesic mathematical model and the set slip coefficient;
whether the set slip coefficient satisfies a set requirement is judged according to the length of the transition segment and the length of the cylindrical segment;
if the length of the transition segment is greater than the length of the cylindrical segment, the length of the cylindrical segment is increased or the set slip coefficient within a set range is changed to obtain modification information;
the non-geodesic trajectory information of the cylindrical segment is determined according to the non-geodesic mathematical model and the modification information;
if the length of the transition segment is not greater than the length of the cylindrical segment, the non-geodesic trajectory information of the cylindrical segment is determined according to the non-geodesic mathematical model.

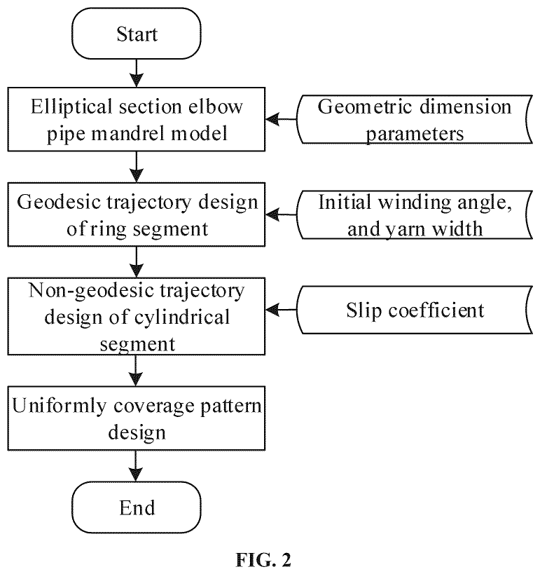

In brief, the method provided by the present invention is shown in FIG. 2. The method including: (1) according to the input geometric dimension parameters, the geometric model of the elliptical section elbow pipe mandrel is established; (2) for the ring segment of the elbow pipe, according to the input initial winding angle and the yarn width, the number of yarns that can uniformly cover the elliptical section is determined, the initial winding angle of each geodesic path is calculated, and a uniformly distributed ring segment trajectory is designed; (3) for the cylindrical segment of the elbow pipe, the slip coefficient between the fiber and the mandrel/ply is considered, the non-geodesic mathematical model is used to calculate the axial length of the fiber transition in the cylindrical segment and design the non-geodesic trajectory to avoid the slip phenomenon in the filament winding process; and (4) for the elbow pipe composed of the middle ring segment and the two ends of the cylindrical segment, the center rotation angle of the fiber path in one cycle is calculated, the dwell angle of the end face of the cylindrical segment is determined according to the continued fraction theory, so as to generate a uniform coverage and stable pattern.

In practical applications, the specific implementation steps of the method are as follows:
step A: the mandrel geometric dimension parameters of the elliptical section elbow pipe are obtained, and the OpenGL drawing function is used to establish the mandrel geometric model; the mandrel is composed of the middle elliptical section ring-like elbow pipe (ring segment) and the elliptical section pipe (cylindrical segment) on both sides.

A mandrel geometric model, wherein the left and right ends of the mandrel geometric model are elliptical section cylindrical models, and the middle is an elliptical section elbow pipe model, the length of the cylindrical at both ends is recorded as L, the bending radius of the middle elbow pipe section is recorded as R, the bending angle is θ, and the elliptical section long and short semi-axis of the elbow pipe are recorded as a and b, respectively.

Step A is specified as follows:
the mandrel geometric dimension parameters of the elliptical section elbow pipe are obtained; the mandrel geometric dimension parameters include the bending radius R, the bending angle θ, the elliptical long semi-axis a, the elliptical short semi-axis b, and the cylindrical length L at both sides of the elbow pipe. Assuming that the parametric expression of the curved surface of the elbow pipe ring segment is T(θ, φ), then:

$$\vec{T} ( θ , φ ) = {[ \begin{matrix}( R + a cos φ ) cos θ \\ ( R + a cos φ ) sin θ \\ b sin φ\end{matrix} ]}^{T} . \qquad ( 1 )$$

According to the knowledge of differential geometry, the first fundamental form is as follows:

$$\{ \begin{matrix}E = \vert \vec{{T}_{θ}} {\vert}^{2} = {( R + a cos φ )}^{2} \\ F = 0 \\ G = \vert \vec{{T}_{φ}} {\vert}^{2} = {a}^{2} {sin}^{2} φ + {b}^{2} {cos}^{2} φ\end{matrix} . \qquad ( 2 )$$

According to the knowledge of differential geometry, the geodesic mathematical model of the elbow pipe ring segment can be obtained:

$$\frac{d {α}_{1}}{d {φ}_{1}} = - \frac{a sin {φ}_{1}}{R + a cos {φ}_{1}} cot {α}_{1} . \qquad ( 3 )$$

$$\frac{d θ}{d {φ}_{1}} = \frac{\sqrt{G}}{R + a cos {φ}_{1}} cot {α}_{1} . \qquad ( 4 )$$

Step B: for the ring segment of the elbow pipe, an initial winding angle and the yarn width is given, the number of yarns that can uniformly cover the elliptical section is determined, and the winding angle of each yarn at the beginning of the ring segment is calculated, and based on this, a uniformly distributed geodesic path of the ring segment is designed.

Step B is specified as follows:
the bending angle increment spanned by the geodesic is calculated after the center rotation angle passes a 2π period; according to the bending angle increment, the number of yarns required to cover a 2π period outer arc is calculated; for the above-mentioned obtained number of yarns, the winding angle of each yarn at the starting point when winding from the ring segment is calculated; according to the winding angle of the starting point, the center rotation angle and winding angle of each geodesic fiber doffing path are calculated.

Further, step B is specified as follows:
for the ring segment of the elbow pipe, an initial winding angle α₀ is given, and the bending angle θ_{cycle} that the center rotation angle φ passes through a 2π-period geodesic is calculated.

$${θ}_{c y c l e} = {\int }_{0}^{2 π} \frac{\sqrt{G} C}{( R + a cos φ ) \sqrt{E - {C}^{2}}} d φ . \qquad ( 5 )$$

G is obtained by the formula (2), and C is a constant related to the initial winding angle.

Based on the bending angle θ_{cycle}, the number of yarns required to cover one cycle of the outer arc is calculated. It can be seen from the geodesic mathematical model of the elbow pipe ring segment that the geodesic has the same winding angle at the outer arc of the elbow pipe. Assuming that the width of the yarn is w, then the width of the yarn actually covering the outer arc is

$$\frac{w}{sin {α}_{0}} ,$$

then the number of yarns required to be covered with one cycle of the outer arc is:

$$N = int ( \frac{( a + R ) {θ}_{cycle} sin {α}_{0}}{w} ) + 1. \qquad ( 6 )$$

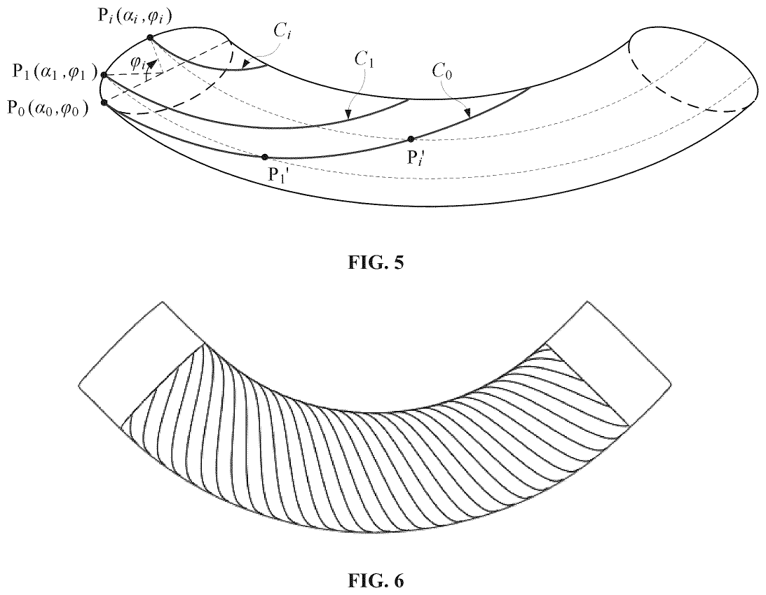

The initial winding angle of each yarn when it is wound from the ring segment is calculated; assuming that the winding starting point of the first yarn is P₀ and the winding angle is α₀, as shown in FIG. 5.

According to the geodesic mathematical model of the elbow pipe ring segment, the winding angle of the fiber path starting from point P and the center rotation angle φ passing through a 2π period can be obtained. The elbow pipe is a part of a ring, any geodesic path on the elbow pipe is still geodesic after being rotated by a certain angle around the z-axis. Therefore, for the fiber path with the starting point P₁, the fiber path with the starting point P₀ can be rotated by a certain angle about the z-axis so that the adjacent yarns are staggered by one yarn width, as shown in FIG. 5. According to this property, the initial winding angle of the fiber path from the point P₁ is the winding angle α₁ at the intersection point P₁′ of the initial path curve C₀ and the meridian passing point P₁. Similarly, the initial winding angle αᵢ of any starting point Pᵢ can be obtained.

According to formulas (3) and (4), the geodesic path Cᵢ is calculated when the point Pᵢ is taken as the initial point and the winding angle αᵢ is taken as the winding angle to rotate any center rotation angle φ. The winding angle and the center rotation angle are:

$${α}_{1} = {\int }_{0}^{φ} - \frac{a sin {φ}_{1}}{R + a cos {φ}_{1}} cot {α}_{1} d {φ}_{1} . \qquad ( 7 )$$

$$θ = {\int }_{0}^{φ} \frac{\sqrt{G}}{R + a cos {φ}_{1}} cot {α}_{1} d {φ}_{1} . \qquad ( 8 )$$

Step C: for the cylindrical segment of the elbow pipe, the slip coefficient between the fiber and the mandrel/ply is input, and the non-geodesic mathematical model is used to calculate the axial length of the fiber transition in the cylindrical segment; if the axial length of the transition section is less than the cylindrical length in step A, the cylindrical segment non-geodesic trajectory can be designed, otherwise the slip coefficient needs to be optimized or the cylindrical length needs to be increased.

The slip coefficient between the fiber and the mandrel/ply is introduced, and the end winding angle of the fiber path at the end of the ring segment can be obtained according to step B.

According to the slip coefficient, the length of the cylindrical segment and the end winding angle, the axial length of the fiber transition in the cylindrical segment is calculated to determine whether the slip coefficient satisfies the requirements.

If the axial length of the transition segment is less than the length of the cylindrical segment in step A, the non-geodesic path of the cylindrical segment is calculated based on the end winding angle, including the non-geodesic center rotation angle and the winding angle.

If the axial length of the transition segment is greater than the length of the cylindrical segment in step A, it is necessary to increase the cylindrical length L or optimize the slip coefficient.

Step C is specified as follows:

The parameter expression of the curved surface of the elbow pipe cylindrical segment is:

$$\begin{matrix}R ( y , φ ) = ( \begin{matrix}a cos φ \\ y \\ b sin φ\end{matrix} ) & 0 \leq y \leq L , 0 \leq φ \leq 2 π .\end{matrix} \qquad ( 9 )$$

In the formula, y is the axial position information of the central axis.

According to the knowledge of differential geometry, the non-geodesic mathematical model of the cylindrical segment can be obtained:

$$\frac{d {α}_{2}}{dy} = - \frac{λ ab {sin}^{2} {α}_{2}}{G \sqrt{G} cos {α}_{2}} . \qquad ( 10 )$$

$$\frac{d {φ}_{2}}{dy} = \frac{tan {α}_{2}}{\sqrt{G}} . \qquad ( 11 )$$

Assuming that the slip coefficient λ between the fiber and the mandrel/ply, the minimum transition segment length Lₜ of the elbow pipe cylindrical segment is:

$${L}_{t} = \frac{G \sqrt{G}}{λ ab} ( \frac{1}{sin {α}_{t}} - \frac{1}{sin \frac{π}{2}} ) . \qquad ( 12 )$$

In the formula, αₜ is the winding angle of the fiber path at the junction of the ring segment and the cylindrical segment.

The non-geodesic path of the cylindrical segment is calculated; according to the formulas (10) and (11), the winding angle α and the center rotation angle φ of the fiber doffing path are obtained, that is:

$${α}_{2} = {\int }_{0}^{y} - \frac{λ ab {sin}^{2} {α}_{2}}{G \sqrt{G} cos {α}_{2}} dy . \qquad ( 13 )$$

$${φ}_{2} = {\int }_{0}^{y} \frac{tan {α}_{2}}{\sqrt{G}} dy . \qquad ( 14 )$$

Step D: for the elbow pipe composed of the middle ring segment and the two ends of the cylindrical segment, the center rotation angle of all possible single cycle paths is calculated according to the continued fraction theory, and the center rotation angle of the fiber path obtained by step B and step C is combined to determine the dwell angle of the end face of the cylindrical segment, thereby generating a uniform coverage and stable pattern.

According to steps B and C, the center rotation angle of each part of the elbow pipe is obtained, and the end face dwell angle of the cylindrical segment at both ends is calculated according to the center rotation angle and the continued fraction principle; all paths are connected to obtain the fiber doffing path of the whole cycle.

According to steps B and C, the center rotation angle or of the elbow pipe ring segment and the center rotation angles φ_{lc} and φ_{rc} of the left and right cylindrical segments are obtained. Because the elliptical section elbow is a non-axisymmetric structure, if the multi-cut winding method is adopted, it may lead to the phenomenon of fiber overlapping overhead. Therefore, the single-cut point winding method is adopted. At the end of a reciprocating process, the pay-out eye is turned over a center rotation angle increment of the yarn width, after N reciprocating, the yarn sheet can be uniformly distributed on the surface of the elbow pipe mandrel, thereby determining all possible center rotation angles φ′ₐₗₗ of a reciprocating winding process. Under the condition that the initial winding angle α₀ is given, the sum of the center rotation angles (φₜ, φ_{lc}, φ_{rc}) of the ring segment and the cylindrical segment is a fixed value. Therefore, as long as the dwell angle φ_{d} at the sealed head of the cylindrical segment on both sides is properly adjusted, the actual winding center rotation angle dan is consistent with the center rotation angle φ′ₐₗₗ.

Specifically, the center rotation angle of a single cycle winding path that completes a single tangent point pattern is:

$${φ}_{all}^{′} = ( 1 + N ) 360 ° \pm Δ φ . \qquad ( 15 )$$

In an actual reciprocating winding process, the sum of the center rotation angles of the ring segment and the cylindrical segment is:

$${φ}_{sum} = 2 {φ}_{t} + 2 ( {φ}_{lc} + {φ}_{rc} ) . \qquad ( 16 )$$

Then, the dwell angle φ_{d} at the end face of the cylindrical segment can be expressed as:

$${φ}_{d} = ( {φ}_{all}^{′} - {φ}_{sum} ) / 2. \qquad ( 17 )$$

In summary, the fiber doffing path of the whole cycle is obtained by connecting the geodesic path of the ring segment, the non-geodesic path of the cylindrical segment and the stay path of the end face of the cylindrical segment.

According to the center rotation angle φ₁ and bending angle θ obtained by step B, the path point of the fiber doffing corresponding to the ring segment is calculated, that is:

$$\{ \begin{matrix}{x}_{1} = ( R + a cos φ ) cos θ \\ {y}_{1} = ( R + a cos φ ) sin θ \\ {z}_{1} = b sin φ\end{matrix} . \qquad ( 18 )$$

According to the center rotation angle θ₂ and axial position y obtained by step C, the path point of the cylindrical segment fiber doffing is calculated, that is:

$$\{ \begin{matrix}{x}_{2} = a cos φ \\ {y}_{2} = y \\ {z}_{2} = b sin φ\end{matrix} . \qquad ( 19 )$$

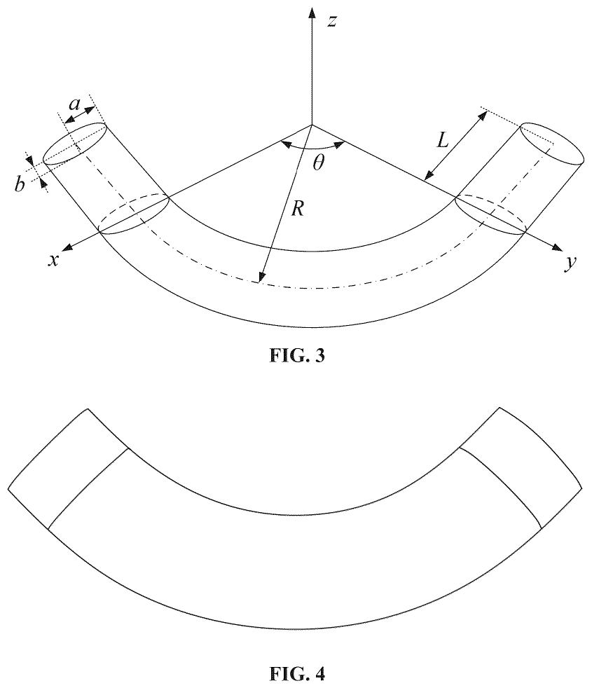

As a specific embodiment:
Step A: the geometric dimension parameters of the mandrel are obtained, and the OpenGL drawing function is used to establish the mandrel model according to the mandrel geometric dimension parameters. The mandrel geometric dimension parameters include the bending radius R, the bending angle θ, the elliptical long semi-axis a, the elliptical short semi-axis b, and the cylindrical length L at both sides of the elbow pipe, as shown in FIG. 3.

In this embodiment, the specific dimension parameters of the elliptical section elbow pipe mandrel are selected as follows: bending radius R=100 mm, bending angle θ=90°, cylindrical length L=20 mm, and the elliptical long and short semi-axis are a=20 mm, b=10 mm, respectively, the mandrel geometric mode is obtained by using the OpenGL drawing function, as shown in FIG. 4.
Step B: for the ring segment of the elbow pipe, an initial winding angle α₀ and a yarn width w is given to determine the number of yarns that can uniformly cover the elliptical section, and the winding angle αᵢ of each yarn at the beginning of the ring segment is calculated, a uniformly distributed geodesic trajectory of the ring segment is designed according to the winding angle αᵢ.

In this embodiment, the given the initial winding angle α₀=65°, the bending angle θ_{cycle}=35.04° that the center rotation angle φ crosses through a 2π period geodesic is calculated.

Assuming that the yarn width w=6 mm, the actual width of the outer arc covered by the yarn is:

$$\frac{w}{sin {α}_{0}} .$$

The number of yarn required to cover a periodic outer arc is:

$$N = int ( \frac{( a + R ) {θ}_{cycle} sin {α}_{0}}{w} ) + 1 = 15 .$$

The initial winding angle of each yarn from the ring segment is calculated, assuming that the winding starting point of the first yarn is P₀, and the winding angle is α₀. According to the geodesic mathematical model of the ring segment, the winding angle of the fiber path starting from P₀ point in a 2α period can be obtained. For the fiber path with the starting point P₁, according to the geodesic property of the elbow pipe, it is essentially obtained by the rotation of the path C₀, and the rotation angle is the distance between the path C₀ and the path C₁ to stagger a yarn width. Therefore, the winding angle of the fiber path of the point P₁ is the winding angle of the point P₁′, so the winding angle αᵢ of any starting point Pᵢ can be obtained according to this method, as shown in FIG. 5.

After calculating the winding angle αᵢ of any starting point Pᵢ, the center rotation angle and winding angle of the fiber doffing path are solved according to the geodesic mathematical model, and the numerical solution is obtained by using the fourth-order Runge-Kutta method, the simulation results of the fiber doffing path in the ring section is obtained by using the OpenGL drawing function, as shown in FIG. 6.

Step C: for the cylindrical segment of the elbow pipe, the slip coefficient λ between the fiber and the mandrel/ply is introduced, and the non-geodesic mathematical model is used to calculate the axial length of the fiber transition in the cylindrical segment, if the axial length of the transition segment is less than the cylindrical length L of step A, the non-geodesic trajectory of the cylindrical segment can be designed, otherwise the slip coefficient needs to be optimized or the cylindrical length needs to be increased.

According to the preset cylindrical length and winding angle, whether the slip coefficient satisfies the requirements is judged, the range of slip coefficient is −0.12-0.12, which is substituted into formula (12) to obtain:

Lₜ≤L

it is judged that the length of the cylindrical segment satisfies the requirements by calculation, and the fiber will not appear in the phenomenon of sliding yarn. And in step B, the winding angle of the fiber path from the ring segment to the cylindrical segment can be obtained, and then the numerical solution is obtained by using the fourth-order Rung-Kutta method according to the non-geodesic mathematical model of the cylindrical segment.

Step D: for the elbow pipe composed of the middle ring segment and the two ends of the cylindrical segment, according to the geodesic fiber path obtained by step B and the non-geodesic trajectory obtained by step C, the center rotation angle and the winding angle of fiber path of each cycle is obtained, according to the continued fraction theory, the dwell angle of the end face of the cylindrical is determined, so as to generate a uniformly covered and stable pattern.

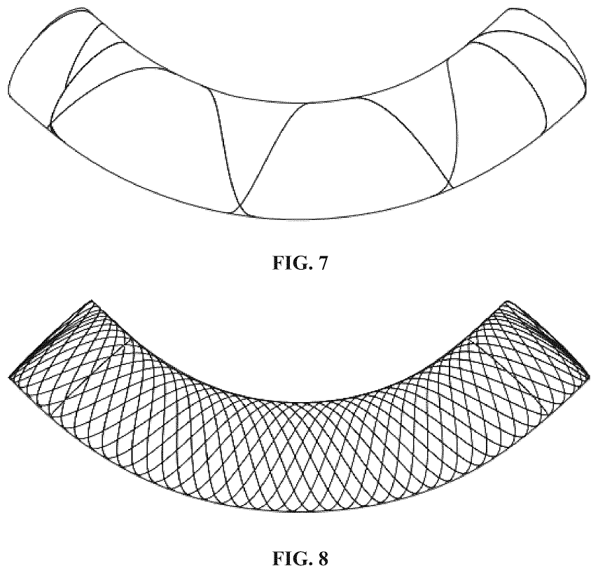

and the dwell angle is solved according to the center rotation angle or of the elbow pipe ring segment and the center rotation angle φ_{lc} and φ_{rc} of the left and right cylindrical segments obtained by step B and step C, the simulation results of the fiber doffing path of one single cycle are obtained by using the OpenGL drawing function, as shown in FIG. 7. After N cycles, the simulation results of the fiber doffing path of all cycles are obtained, as shown in FIG. 8.

### Embodiment 2

A computer device, the computer device includes: memory, a processor, and a computer program stored on the memory and runnable on the processor, the processor executing the computer program to implement the steps of the method for pattern design in filament winding of embodiment 1.

### Embodiment 3

A computer-readable storage medium, the computer-readable storage medium has stored a computer program, the steps of the method for pattern design in filament winding of embodiment 1 are implemented when the computer program is executed by the processor.

### Embodiment 4

A computer program product, the computer program product includes a computer program, the steps of the method for pattern design in filament winding of embodiment 1 are implemented when the computer program is executed by the processor.

### Embodiment 5

A computer device, the computer device can be a database. The computer device includes a processor, memory, Input/Output (I/O) and communication interface. Wherein the processor, memory and Input/Output are connected through the system bus, and the communication interface is connected to the system bus through the Input/Output. Wherein the processor of the computer device is used to provide computing and control capabilities. The memory of the computer device includes a non-volatile storage medium and a memory. The non-volatile storage medium stores operating systems, computer programs, and databases. The memory provides an environment for the operation of operating systems and computer programs in non-volatile storage media. The database of the computer device is used to store pending transactions. The Input/Output of the computer device is used to exchange information between the processor and the external device. The communication interface of the computer device is used to communicate with the external terminal through the network connection. The the method for pattern design in filament winding of embodiment 1 is implemented when the computer program executed by the processor.

It should be noted that the object information (including but not limited to object device information, object personal information, etc.) and data (including but not limited to data for analysis, stored data, displayed data, etc.) involved in the present invention are all information and data authorized by the object or fully authorized by the parties, and the collection, use and processing of relevant data need to comply with relevant laws, regulations and standards of relevant countries and regions.

The general technical personnel in this field can understand all or part of the process of implementing the above embodiment method, which can be completed by the computer program to instruct the relevant hardware, the computer program can be stored in a non-volatile computer readable storage medium, when the computer program is executed, it can include the process of the embodiment of the above methods. Wherein, any reference to memory, database, or other medium used in each embodiment provided by the present invention may include at least one of non-volatile and volatile memory. Non-volatile memory can include Read-Only Memory (ROM), tape, floppy disk, flash memory, optical memory, high-density embedded non-volatile memory, resistive memory (ReRAM), Magnetoresistive Random Access Memory (MRAM), Ferroelectric Random Access Memory (FRAM), Phase Change Memory (PCM), graphene memory, etc. The volatile memory can include random access memory (RAM) or external high-speed buffer memory. As an illustration rather than a limitation, RAM can be in many forms, such as Static Random Access Memory (SRAM) or Dynamic Random Access Memory (DRAM). The database involved in each embodiment provided by the present invention may include at least one of the relational database and the non-relational database. Non-relational databases can include blockchain-based distributed databases, etc., and are not limited to this. The processors involved in each embodiment provided by the present invention can be general-purpose processors, central processors, graphics processors, digital signal processors, programmable logic devices, data processing logic devices based on quantum computing, etc., which are not limited to this.

The technical features of the above embodiments can be arbitrarily combined. In order to make the description concise, all possible combinations of the technical features of the above embodiments are not described. However, as long as there is no contradiction in the combination of these technical features, it should be considered as the scope of this specification.

In this paper, a specific example is used to explain the principle and implementation of the present invention, the above embodiments are only used to help understand the method and core idea of the present invention. Meanwhile, for the general technical personnel in this field, according to the idea of the present invention, there will be changes in the specific implementation methods and application scope. In summary, the content of this specification should not be understood as a limitation to the present invention.

What is claimed is:

1. A method for pattern design in filament winding, wherein the method comprises:
acquiring parameter data of a target elbow pipe mandrel; the parameter data comprises: geometric dimension parameters;
constructing a mandrel geometric model according to the geometric dimension parameters; the mandrel geometric model comprises a geodesic mathematical model of a ring segment and a non-geodesic mathematical model of a cylindrical segment; the ring segment is an elliptical section annular elbow pipe; the cylindrical segment is an elliptical section pipe;
determining number of yarns of the ring segment according to the geodesic mathematical model and set parameter data, and determining geodesic trajectory information of the ring segment; the set parameter data comprises: an initial winding angle and a yarn width; the geodesic trajectory information of the ring segment comprises: a winding angle and a center rotation angle;
determining non-geodesic trajectory information of the cylindrical segment according to the non-geodesic mathematical model and a set slip coefficient; the non-geodesic trajectory information of the cylindrical segment comprises: a fiber path winding angle and a fiber path center rotation angle; and
determining a filament winding pattern according to the geodesic trajectory information of the ring segment and the non-geodesic trajectory information of the cylindrical segment by using a continued fraction theory;
a method for determining the geodesic trajectory information of the ring segment comprises:
determining a bending angle according to the initial winding angle; the bending angle is an angle spanned by a geodesic within a set period of the center rotation angle;
determining the number of yarns corresponding to an outer arc of a set period according to the bending angle and the yarn width;
determining path information about each yarn according to the geodesic mathematical model and set parameter data; and
determining the geodesic trajectory information of the ring segment according to all path information;
the non-geodesic trajectory information of the cylindrical segment is determined according to the non-geodesic mathematical model and the set slip coefficient, comprising:
determining a length of transition segment according to the non-geodesic mathematical model and the set slip coefficient;
judging whether the set slip coefficient satisfies a set requirement according to the length of the transition segment and a length of the cylindrical segment;
when the length of the transition segment is greater than the length of the cylindrical segment, increasing the length of the cylindrical segment or changing the set slip coefficient within a set range to obtain modification information;
determining non-geodesic trajectory information of the cylindrical segment according to the non-geodesic mathematical model and the modification information;
when the length of the transition segment is less than or equal to the length of the cylindrical segment, determining the non-geodesic trajectory information of the cylindrical segment according to the non-geodesic mathematical model.

2. The method for the pattern design in filament winding according to claim 1, wherein a construction method for the mandrel geometric model comprises:
determining a parametric expression according to the geometric dimension parameters; the parametric expression comprises:
$$\vec{T} ( θ , φ ) = {[ \begin{matrix}( R + a cos φ ) cos θ \\ ( R + a cos φ ) sin θ \\ b sin φ\end{matrix} ]}^{T} ;$$
obtaining the mandrel geometric model by processing the parametric expression according to a differential geometry theory; the mandrel geometric model comprises:
$$\{ \begin{matrix}E = {\vert \vec{{T}_{θ}} \vert}^{2} = {( R + a cos φ )}^{2} \\ F = 0 \\ G = {\vert \vec{{T}_{φ}} \vert}^{2} = {a}^{2} {sin}^{2} φ + {b}^{2} {cos}^{2} φ\end{matrix}$$
wherein \vec{T}(θ, φ) is a parameter vector; R is a bending radius; a is an elliptical long semi-axis of elliptical section; b is an elliptical short semi-axis of elliptical section; θ is a bending angle; φ is a center rotation angle; T is a matrix transpose; \vec{T}_{θ} is a partial derivative of the bending angle θ; \vec{T}_{φ} is a partial derivative of the center rotation angle φ; E is a first expression of the parametric expression; F is a second expression of the parametric expression; G is a third expression about the parametric expression.

3. The method for the pattern design in filament winding according to claim 2, wherein the geodesic mathematical model comprises:
$$\frac{d {α}_{1}}{d {φ}_{1}} = - \frac{a sin {φ}_{1}}{R + a cos {φ}_{1}} cot {α}_{1} ;$$
$$\frac{d θ}{d {φ}_{1}} = \frac{\sqrt{G}}{R + a cos {φ}_{1}} cot {α}_{1} ;$$
wherein α₁ is a winding angle; φ₁ is a center rotation angle; θ is the bending angle; a is the elliptical long semi-axis of elliptical section; R is the bending radius; G is the third expression about the parametric expression.

4. The method for the pattern design in filament winding according to claim 3, wherein the non-geodesic mathematical model comprises:
$$\frac{d {α}_{2}}{dy} = - \frac{λ ab {sin}^{2} {α}_{2}}{G \sqrt{G} cos {α}_{2}} ;$$
$$\frac{d {φ}_{2}}{dy} = \frac{tan {α}_{2}}{\sqrt{G}} ;$$
wherein α₂ is a fiber path winding angle; a is the elliptical long semi-axis of elliptical section; b is the elliptical short semi-axis of elliptical section; G is the third expression about the parametric expression; φ₂ is a fiber path center rotation angle; λ is a set slip coefficient; y is axial position information of a central axis.

5. A computer device, comprising: memory, a processor, and computer instructions stored on the memory and runnable on the processor, wherein the processor executes the computer instructions to implement the steps of the method for the pattern design in filament winding according to claim 1.

6. A computer-readable storage medium, wherein the computer-readable storage medium stores a computer program, wherein the steps of the method for the pattern design in filament winding according to claim 1 are implemented when the computer program is executed by a processor.

7. A computer program product, comprising a computer program, wherein the steps of the method for the pattern design in filament winding according to claim 1 are implemented when the computer program is executed by a processor.

8. The computer device according to claim 5, wherein in the method for the pattern design in filament winding, a construction method for the mandrel geometric model comprises:
determining a parametric expression according to the geometric dimension parameters; the parametric expression comprises:
$$\vec{T} ( θ , φ ) = {[ \begin{matrix}( R + a cos φ ) cos θ \\ ( R + a cos φ ) sin θ \\ b sin φ\end{matrix} ]}^{T} ;$$
obtaining the mandrel geometric model by processing the parametric expression according to a differential geometry theory; the mandrel geometric model comprises:
$$\{ \begin{matrix}E = {\vert \vec{{T}_{θ}} \vert}^{2} = {( R + a cos φ )}^{2} \\ F = 0 \\ G = {\vert \vec{{T}_{φ}} \vert}^{2} = {a}^{2} {sin}^{2} φ + {b}^{2} {cos}^{2} φ\end{matrix}$$
wherein \vec{T}(θ, φ) is a parameter vector; R is a bending radius; a is an elliptical long semi-axis of elliptical section; b is an elliptical short semi-axis of elliptical section; θ is a bending angle; φ is a center rotation angle; T is a matrix transpose; \vec{T}_{θ} is a partial derivative of the bending angle θ; \vec{T}_{φ} is a partial derivative of the center rotation angle φ; E is a first expression of the parametric expression; F is a second expression of the parametric expression; G is a third expression about the parametric expression.

9. The computer device according to claim 8, wherein in the method for the pattern design in filament winding, the geodesic mathematical model comprises:
$$\frac{d {α}_{1}}{d {φ}_{1}} = - \frac{a sin {φ}_{1}}{R + a cos {φ}_{1}} cot {α}_{1} ;$$
$$\frac{d θ}{d {φ}_{1}} = \frac{\sqrt{G}}{R + a cos {φ}_{1}} cot {α}_{1} ;$$
wherein α₁ is a winding angle; φ₁ is a center rotation angle; θ is the bending angle; a is the elliptical long semi-axis of elliptical section; R is the bending radius; G is the third expression about the parametric expression.

10. The computer device according to claim 9, wherein in the method for the pattern design in filament winding, the non-geodesic mathematical model comprises:
$$\frac{d {α}_{2}}{dy} = - \frac{λ ab {sin}^{2} {α}_{2}}{G \sqrt{G} cos {α}_{2}} ;$$
$$\frac{d {φ}_{2}}{dy} = \frac{tan {α}_{2}}{\sqrt{G}} ;$$
wherein α₂ is a fiber path winding angle; a is the elliptical long semi-axis of elliptical section; b is the elliptical short semi-axis of elliptical section; G is the third expression about the parametric expression; φ₂ is a fiber path center rotation angle; λ is a set slip coefficient; y is axial position information of a central axis.

11. The computer-readable storage medium according to claim 6, wherein in the method for the pattern design in filament winding, a construction method for the mandrel geometric model comprises:
determining a parametric expression according to the geometric dimension parameters; the parametric expression comprises:
$$\vec{T} ( θ , φ ) = {[ \begin{matrix}( R + a cos φ ) cos θ \\ ( R + a cos φ ) sin θ \\ b sin φ\end{matrix} ]}^{T} ;$$
obtaining the mandrel geometric model by processing the parametric expression according to a differential geometry theory; the mandrel geometric model comprises:
$$\{ \begin{matrix}E = {\vert \vec{{T}_{θ}} \vert}^{2} = {( R + a cos φ )}^{2} \\ F = 0 \\ G = {\vert \vec{{T}_{φ}} \vert}^{2} = {a}^{2} {sin}^{2} φ + {b}^{2} {cos}^{2} φ\end{matrix}$$
wherein \vec{T}(θ, φ) is a parameter vector; R is a bending radius; a is an elliptical long semi-axis of elliptical section; b is an elliptical short semi-axis of elliptical section; θ is a bending angle; φ is a center rotation angle; T is a matrix transpose; \vec{T}_{θ} is a partial derivative of the bending angle θ; \vec{T}_{φ} is a partial derivative of the center rotation angle φ; E is a first expression of the parametric expression; F is a second expression of the parametric expression; G is a third expression about the parametric expression.

12. The computer-readable storage medium according to claim 11, wherein in the method for the pattern design in filament winding, the geodesic mathematical model comprises:
$$\frac{d {α}_{1}}{d {φ}_{1}} = - \frac{a sin {φ}_{1}}{R + a cos {φ}_{1}} cot {α}_{1} ;$$
$$\frac{d θ}{d {φ}_{1}} = \frac{\sqrt{G}}{R + a cos {φ}_{1}} cot {α}_{1} ;$$
wherein α₁ is a winding angle; φ₁ is a center rotation angle; θ is the bending angle; a is the elliptical long semi-axis of elliptical section; R is the bending radius; G is the third expression about the parametric expression.

13. The computer-readable storage medium according to claim 12, wherein in the method for the pattern design in filament winding, the non-geodesic mathematical model comprises:
$$\frac{d {α}_{2}}{dy} = - \frac{λ ab {sin}^{2} {α}_{2}}{G \sqrt{G} cos {α}_{2}} ;$$
$$\frac{d {φ}_{2}}{dy} = \frac{tan {α}_{2}}{\sqrt{G}} ;$$
wherein α₂ is a fiber path winding angle; a is the elliptical long semi-axis of elliptical section; b is the elliptical short semi-axis of elliptical section; G is the third expression about the parametric expression; φ₂ is a fiber path center rotation angle; λ is a set slip coefficient; y is axial position information of a central axis.

14. The computer program product according to claim 7, wherein in the method for the pattern design in filament winding, a construction method for the mandrel geometric model comprises:
determining a parametric expression according to the geometric dimension parameters; the parametric expression comprises:
$$\vec{T} ( θ , φ ) = {[ \begin{matrix}( R + a cos φ ) cos θ \\ ( R + a cos φ ) sin θ \\ b sin φ\end{matrix} ]}^{T} ;$$
obtaining the mandrel geometric model by processing the parametric expression according to a differential geometry theory; the mandrel geometric model comprises:
$$\{ \begin{matrix}E = {\vert \vec{{T}_{θ}} \vert}^{2} = {( R + a cos φ )}^{2} \\ F = 0 \\ G = {\vert \vec{{T}_{φ}} \vert}^{2} = {a}^{2} {sin}^{2} φ + {b}^{2} {cos}^{2} φ\end{matrix}$$
wherein \vec{T}(θ, φ) is a parameter vector; R is a bending radius; a is an elliptical long semi-axis of elliptical section; b is an elliptical short semi-axis of elliptical section; θ is a bending angle; φ is a center rotation angle; T is a matrix transpose; \vec{T}_{θ} is a partial derivative of the bending angle θ; \vec{T}_{φ} is a partial derivative of the center rotation angle φ; E is a first expression of the parametric expression; F is a second expression of the parametric expression; G is a third expression about the parametric expression.

15. The computer program product according to claim 14, wherein in the method for the pattern design in filament winding, the geodesic mathematical model comprises:
$$\frac{d {α}_{1}}{d {φ}_{1}} = - \frac{a sin {φ}_{1}}{R + a cos {φ}_{1}} cot {α}_{1} ;$$
$$\frac{d θ}{d {φ}_{1}} = \frac{\sqrt{G}}{R + a cos {φ}_{1}} cot {α}_{1} ;$$
wherein α₁ is a winding angle; φ₁ is a center rotation angle; θ is the bending angle; a is the elliptical long semi-axis of elliptical section; R is the bending radius; G is the third expression about the parametric expression.

16. The computer program product according to claim 15, wherein in the method for the pattern design in filament winding, the non-geodesic mathematical model comprises:
$$\frac{d {α}_{2}}{dy} = - \frac{λ ab {sin}^{2} {α}_{2}}{G \sqrt{G} cos {α}_{2}} ;$$
$$\frac{d {φ}_{2}}{dy} = \frac{tan {α}_{2}}{\sqrt{G}} ;$$
wherein α₂ is a fiber path winding angle; a is the elliptical long semi-axis of elliptical section; b is the elliptical short semi-axis of elliptical section; G is the third expression about the parametric expression; φ₂ is a fiber path center rotation angle; λ is a set slip coefficient; y is axial position information of a central axis.
